(19) United States
(12) Patent Application Publication
(10) Pub. No.: US 2026/0041098 A1
(43) Pub. Date: Feb. 12, 2026

(54) POLYMERIC BATCH TO PREPARE AN ANTIMICROBIAL MATERIAL AND AIR FILTER

(71) Applicant: IMPORTADORA Y EXPORTADORA JCN LIMITADA, Santiago (CL)

(72) Inventors: Gino Rugeiro CORSINI ACUÑA, Santiago (CL); Alfonso Javier RIVEROS VARGAS, Santiago (CL); Sonia del Pilar JARA MORI, Santiago (CL); Guillermo Adrián WIESE PLAZA, Santiago (CL)

(21) Appl. No.: 18/695,157

(22) PCT Filed: Sep. 23, 2021
(86) PCT No.: PCT/CL2021/050089

§ 371 Date: Jun. 20, 2025

(51) Int. Cl. A01N 59/20; A01N 25/10; A01N 25/12; A01P 1/00; A01P 3/00

(52) U.S. Cl. CPC A01N 59/20; A01N 25/10; A01N 25/12; A01P 1/00; A01P 3/00

(57) ABSTRACT

A polymeric masterbatch is provided to prepare an antimicrobial material and an antimicrobial air filter prepared with said material, which serves to filter air and reduce the growth of bacteria and fungi such as E. coli, S. aureus, Botrytis cinerea, and Aspergillus niger.

### FIELD OF THE INVENTION

The present invention relates to an antimicrobial masterbatch comprising a polyethylene polymer, copper compounds and nano-copper. It also refers to antimicrobial polymeric materials/matrices generated from the masterbatch and to derivative products produced with the matrix or antimicrobial material derived therefrom. More particularly, the present invention relates to an antimicrobial filter composed of polymeric antimicrobial materials of the present invention.

### BACKGROUND

It is widely recognized that exposure to bacterial pathogens such as Neisseria meningitidis, Escherichia coli, Staphylococcus aureus, among others, can cause serious harm to human health. The search for new materials with antimicrobial characteristics has been part of the approach used over the last decade to prevent and reduce contamination and the effects of these types of microorganisms.

A particular source of contamination is air conditioning ducts and filters for the control airflow and indoor temperature in buildings, industries, automobiles, and others. The conditions of humidity, darkness, and temperature in air conditioners and their ducts create the perfect environment for the establishment and proliferation of fungi and bacteria, which are associated with health problems such as allergies, asthma, and respiratory symptoms.

The materials currently used in air conditioning ducts and components do not effectively or consistently eliminate or prevent the presence of microorganisms, nor at a beneficial production cost.

So far, polymeric materials functionalized or treated with active principles that grant antibacterial properties have been proposed, and the addition of copper compounds or copper derivatives for such purpose is well recognized.

—Polymeric Materials with Copper or Nano-Copper Compounds

Polymeric matrices and derivatives comprising some copper compound or nanometric copper structures have been described to provide an antimicrobial effect.

In WO 2014117286 A1 (CL201300332), an impregnable matrix of vegetal, animal, or synthetic origin, or mixtures thereof in various proportions, is disclosed, containing an antimicrobial compound corresponding to Cu₄SO₄(OH)₆.

In CL201500921, a cellulose-based product or material is disclosed that contains a biocidal agent. The biocidal agent comprises copper microparticles with laminar morphologies, where the microparticles are incorporated at a ratio of 0.01 to 0.15 grams of copper microparticles per gram of cellulose in the final product.

WO2006100665A2 describes the addition of a small percentage of Cu²⁺ in the form of copper oxide particles insoluble in water to a polymer suspension, allowing the formation of an antimicrobial material for use in food packaging bags, product bags, flower bags, seed bags, and even as a layer in cadaver bags.

WO2012138439A2 discloses articles that contain a matrix and a plurality of copper nanoparticles in the matrix material that have at least partially fused. The copper nanoparticles have a size smaller than approximately 20 nm.

WO2013001172A1 discloses an antimicrobial copolymer composition obtained by reacting an unsaturated carboxylic acid copolymer with at least one source of metallic ions to form an ionomer-type polymer composition containing at least 5% by weight of metallic ions with antimicrobial properties. The molecular weight of said unsaturated carboxylic acid copolymer ranges between 500 and 8000 g/mol, and the metallic ion is selected from the group consisting of silver, copper, zinc, and their mixtures.

In CL201901370, a degradable polymeric composition is disclosed comprising: (a) a polyolefin; (b) two or more transition metal compounds in a total amount of 0.15 to 0.6% by weight; (c) a C14-C24 mono- or polyunsaturated carboxylic acid or its ester, anhydride, or amide in an amount of 0.04 to 0.08% by weight; (d) a synthetic rubber in an amount of 0.04 to 0.2% by weight; and optionally: (e) dry starch in an amount of 0 to 20% by weight; and/or (f) calcium oxide in an amount of 0 to 1% by weight; and/or (g) a phenolic antioxidant stabilizer in an amount of 0 to 0.2% by weight; wherein the transition metal can be copper.

—Polyethylene with Copper and Nano-Copper Compounds

Some documents disclose materials or matrices composed of polyethylene with copper and/or nano-copper for their antimicrobial effect.

In CL201600965, a polymeric material is presented that prevents and/or reduces biofilm formation on surfaces and is useful in the manufacture of medical materials. It comprises a base material such as PVC, polyethylene, polypropylene, or nylon, into which 0.5-5% by mass of core-shell nanostructured copper nanoparticles are incorporated, where the copper nanoparticles are coated with silver.

CN109401022 discloses a low-density polyethylene antibacterial material composed of 65-70% by weight of aniline from the 2-methoxy-N-acetyl group and 30-35% by weight of zinc or copper oxide.

Esmailzadeh, H. and collaborators studied the antibacterial effect of nanocomposites containing CuO against major spoilage bacteria, Bacillus subtilis and Enterobacter aerogenes, comparing the effect with ZnO nanocomposites. Using a twin-screw extruder, 42 nm nanoparticles were inserted into a low-density polyethylene matrix. The nanocomposite with CuO showed stronger antibacterial activity against both microorganisms than ZnO nanocomposites.

In the work of Faranak B. and collaborators, the antibacterial potential of low-density polyethylene packaging films incorporating nanoparticles of silver (Ag), copper oxide (CuO), and zinc oxide (ZnO) was evaluated for coliform bacteria in ultrafiltered (UF) cheese. The number of surviving coliforms decreased after 4 weeks of storage at 4±0.5° C.

In the scientific article by Gayatri B. and collaborators, low-density polyethylene/copper compounds with antimicrobial activity and barrier properties for food packaging were presented. Films with 0.5-3.0% by weight of copper nanoparticles (Cu—NP) in an LLDPE matrix were prepared as 120 μm-thick films for food packaging (Gayatri B. Lomate, et al., 2018).

In the scientific document by Yurkov G. Y., the composition and structure of nanoparticles containing Cu stabilized in a polyethylene matrix were studied. Unlike Fe nanoparticles, the Cu nanoparticles embedded in polyethylene did not oxidize during air storage (Yurkov G. Y., et al., 2001).

In the scientific article by Guriano, Y. and collaborators, a study is presented on the use of cuprous oxide nanoparticles (Cu₂ONP) to prepare composites with linear low-density polyethylene (LLDPE) via coextrusion, thermal adhesion, and fixation with ethyl cyanoacrylate, trimethoxyvinylsilane, and epoxy resin. The composites were examined by scanning electron microscopy and tested. All preparations, except the one obtained by extrusion, eliminated Staphylococcus aureus and Escherichia coli cells within thirty minutes (Gurianov. Y., et al., 2019).

U.S. Pat. No. 9,913,476B2 discloses a masterbatch that contains high concentrations of antimicrobial materials such as copper salts, particularly copper iodide. These masterbatch compositions are added to other materials used to form various manufactured articles with antimicrobial properties. The masterbatch, such as surface-functionalized particles or salts, may be incorporated into porous particles before masterbatch formation. Polyethylene is included in the polymers to be functionalized.

CN106554532A discloses a formula to prepare antibacterial plastic concentrate, where it comprises each component by weight: 50-60 parts of linear low-density polyethylene (LLDPE), 20-30 parts of an antiseptic material, 5-15 parts of a modifying agent. The antiseptic material may correspond to nanoparticles of nano silver, nano zinc oxide, nano cupric oxide, or nano titanium oxide.

CN110408179A discloses a masterbatch of polyethylene terephthalate with copper, dispersing agents, and antioxidants. CN107033556 provides a type of copper masterbatch, characterized by 75-96% polyethylene terephthalate and 4-25% nano copper.

CN104558846A discloses a nano-copper antibacterial plastic masterbatch and its preparation method. The antibacterial plastic masterbatch is prepared from the following components in parts by weight: 1-10 parts antioxidant, 1-20 parts liquid paraffin, 1-30 parts antibacterial agent (nanocopper type), and 40-90 parts plastic body.

CL201801276 provides an antimicrobial composition for coating surfaces to reduce microbial activity on any frequently used substrate or surface, comprising a compound of high-purity micronized metallic copper particles.

Antimicrobial Filters Incorporating Copper and/or Combinations of Polyethylene with Copper

In the scientific article by Vinh Tien Nguyen and collaborators (Vinh Tien N. et al., 2021), a study is presented for the production of antibacterial filters for drinking water disinfection. For the study, a commercial polyethylene terephthalate filter was used, functionalized with copper nanoparticles, copper sulfate, sodium hypophosphite, and polyvinylpyrrolidone. The results of this functionalization of the commercial CuNP/PET filter showed a significant reduction in the number of E. coli and S. aureus colonies.

In WO2018199579A2, a copper filter with antimicrobial properties is disclosed, capable of eliminating mold and bacteria that cause unpleasant odors in filters. This filter can be used in air circulation devices such as air conditioners, cleaners, or air purifiers. The copper filter comprises a support frame and, mounted on it, a copper alloy. This alloy comprises copper with a purity of 99% or more and 60% copper, and a mesh-shaped body.

WO2005092473A1 proposes a material composed of natural or synthetic nonwoven fabric fibers, intended for the elimination of Legionella pneumophila. The filter material may contain a mixture of two or more fibers in a proportion of 0.5 to 99.5%, with each fiber or mixture treated with antibacterial additives in amounts of 0.02-65%. Additional components for these fibers may include high and low-density polyethylene, polyvinyl chloride (PVC), nylon, teflon, silicones, polyesters, polycarbonates, methacrylates, polyolefins, linear hydrocarbons, hardeners, and thermoplastics. Besides copper compounds as the antimicrobial agent (copper sulfate, basic copper carbonate, copper and ammonium carbonate, copper hydroxide, copper oxychloride, copper oxide, copper powder and calcium, copper silicate, and copper sulfate and calcium hydroxide), the filter can be used in conventional filtration systems such as cartridge filters, vacuum filters, press filters, plate filters, membrane filters, centrifugal filters, tangential filters, reverse osmosis, dialysis, air conditioning ducts, respiratory therapy equipment, care facilities, etc.

US2021154610A1 discloses an air filter comprising at least one layer of porous copper with natural antimicrobial properties, designed to capture particles and contribute to human health.

The proposals described thus far are aimed at generating a masterbatch to produce antimicrobial polymeric materials incorporating metallic copper, copper derivatives, or nanometric copper structures. However, these documents present varied results, where different combinations of polymers and copper types may or may not produce an antibacterial effect or may provide different levels of response.

In the case of documents specifically focused on filters, they generally include analyses directed at only one type of bacterium and do not demonstrate the efficiencies observed in the masterbatch, materials, and derived products that are part of the present invention.

It has been demonstrated that the filter produced from the masterbatch-based material is functional and eliminates various pathogenic bacterial agents associated with air conditioning contamination. The particular composition of the proposed masterbatch grants the materials and derived products uniform and effective antimicrobial properties (a higher antibacterial efficiency rate or a better bacterial count reduction effect).

### DETAILED DESCRIPTION OF THE INVENTION

The present invention refers to a masterbatch that comprises a formulation composed of:
25 kg of linear low-density polyethylene (LLDPE),
1.5-3.0 g of nano-copper with a particle size less than 100 nm, composed of 3-50% Cu⁰ and 50-87% Cu₂O,
and 1.5-4.0 kg of copper oxychloride, with a ratio of oxychloride (ppm)/nano copper (ppm) of 120,000-160,000/120.

This masterbatch may additionally comprise:
Antioxidants such as phenols, amines, thiocompounds, calcium stearate;
Pigments and fillers such as carbon black, titanium oxide-anatase, hydrated chromium oxide, fiberglass;
Antistatic additives such as ammonium salts and glycol esters.

An antimicrobial polymeric material made or constituted from the masterbatch and its combination or mixture by extrusion with LLDPE is also provided.

The invention also encompasses an air filter made with the antimicrobial material derived from the masterbatch. All these masterbatches, materials, and derived products have antimicrobial activity against relevant bacteria associated with contamination of air conditioning systems and their ducts.

### Masterbatch

The present invention relates to a polymeric masterbatch to prepare an antimicrobial material comprising:

25 kg of linear low-density polyethylene (LLDPE), 1.5-3.0 g of nano-copper with particle size under 100 nm, composed of 3-50% Cu⁰ and 50-87% Cu₂O, and 1.5-4.0 kg of copper oxychloride, where oxychloride (ppm)/nano copper (ppm) ratio is 120,000-160,000/120.

Additionally, this masterbatch comprises:
Antioxidants: phenols, amines, thiocompounds, calcium stearate;
Pigments and fillers: carbon black, titanium oxide-anatase, hydrated chromium oxide, fiberglass;
Antistatic additives: selected from ammonium salts and glycol esters.

The formulation described is composed of 25 kg of LLDPE, 1.5-3.0 g of nano-copper with particle size under 40 nm and 1.5-4.0 kg of copper oxychloride.

Nano-copper consists of 3-50% Cu⁰ (metallic copper) and 50-87% Cu₂O (copper oxide), particularly corresponds to a mixture of 3.5% Cu⁰ and 86.5% Cu₂O. Particle size is under 100 nm, preferably 40 nm.

In one embodiment of the invention, in the described formulation as a component of the masterbatch, the oxychloride (ppm)/nano copper (ppm) ratio is 120,000/120.

In one of the preferred embodiments of the invention, in the described formulation as a component of the masterbatch, the oxychloride (ppm)/nano copper (ppm) ratio is 140,000/120.

In one embodiment of the invention, in the described formulation as a component of the masterbatch, the oxychloride (ppm)/nano copper (ppm) ratio is 160,000/120.

In one embodiment of the present invention, the formulation comprises 25 kg of LLDPE, 1.5 kg of oxychloride copper and 1.5 g of nano-copper. In another embodiment of the invention, the formulation part of the masterbatch comprises 25 kg of LLDPE, 4.0 kg of oxychloride copper and 3.0 g of nano-copper. In a preferred form of the invention, the formulation of the masterbatch comprises 25 kg of LLDPE, 3.0 kg of oxychloride copper and 3.0 g of nano-copper.

When referring to phenolic antioxidants, compounds such as vitamin E or any commercial derivative or homolog (Irganox® E 201) are included. Examples include N,N′-hexane-1,6-diylbis(3-(3,5-di-tert-butyl-4-hydroxyphenylpropionamide (Irganox® 1098), ethylenebis(oxiethylene)bis-(3-(5-tert-butyl-4-hydroxy-m-tolyl)-propionate (Irganox® 245), 1,3,5-tris(4-tert-butyl-3-hydroxy-2,6-dimethylbenzyl)-1,3,5-triazine-2,4,6-1H,3H,5H)trione (Cyanox® 1790), 1,3,5-trimethyl-2,4,6-tris(3,5-di-tert-butyl-4-hydroxybenzyl)benzene (Ethanox® 330), 1,3,5-tris(3,5-di-tert-butyl-4-hydroxybenzyl)-1,3,5-triazine-2,4,6 (1H,3H,5H)-trione (Ethanox® 314), Ethanox® 310, octadecyl-3-(3,5-di-t-butyl-4-hydroxyphenyl) propionate (Ethanox® 376), 4,4′-methylenebis(2,6-di-tert-butylphenol) (Ethanox® 702), 2,6-di-tert-butyl-N,N-dimethylamino-p-cresol (Ethanox® 703), among others.

Examples of amines include Ethylenediamine (EDA), Diethyltriamine (DATA), Triethylenetetramine (TETA), Tetraethylenepentamine-UHP (TEPA-UHP), Pentaethylenehexamine (PEHA). Also included are ethoxylated amines and alkyl ethoxylated amines (alkyl amine C13 to C15 ethoxylated).

Thio compounds are also included, where a thiocompound is a molecule formed by substituting oxygen in previous molecules with sulfur. Examples of thiocompounds include thiocarbonates such as xanthates and xanthogenates, thiocarbamates and dithiocarbamates, mono-, di-, or tetrasulfides of thiourea and methionine.

The masterbatch can be optionally comprised of pigments and fillers, such as carbon black, titanium dioxide, hydrated chromium oxide, fiberglass).

It may also optionally comprise one or more antistatic additives selected from ammonium salts or glycol esters such as monoester of glycerol, glycerol ester, sorbitol ester, alkoxylated ester, etc.). These materials may be added individually or in combinations (two, three, or more), as solid additives or dispersion additives.

To constitute the formulation as part of the masterbatch, the inventors conducted various tests to first define the type of copper compound and, second, the specific concentrations and proportions of each component to achieve antimicrobial properties.

The inventors initially tested a base formulation of the masterbatch composed of LLDPE mixed or functionalized with copper sulfate as the copper compound and nano-copper. However, when this mixture was added via an extruder machine to achieve LLDPE functionalization, the resulting filaments were not homogeneous and were also soft and brittle, thus they could not be pelletized. This was likely due to the water content in the copper sulfate, which, because of its hygroscopic characteristics, altered the mixture with the LLDPE. Consequently, copper sulfate was discarded as a raw material for LLDPE functionalization.

On the other hand, when a base formulation with copper oxychloride was prepared, it was observed that the resulting LLDPE-functionalized masterbatch exhibited resistance and malleability characteristics similar to a non-functionalized masterbatch, allowing its use and pelletization.

When antimicrobial activity was evaluated at various component concentrations in the base formulation, it was evident that some combinations achieved 99.99% efficiency in eliminating E. coli and S. aureus. This 99.99% efficiency means a reduction of four orders of magnitude in bacterial counts compared to non-functionalized LLDPE, which cannot achieve even a one-order reduction in the tested bacterial strains.

It is important to note that E. coli and S. aureus, from the genera Escherichia and Staphylococcus respectively, are bacterial pathogens commonly described in the literature as contaminants of air conditioning systems and ventilation ducts.

Accordingly, the inventors have specifically defined the best conditions, concentrations, and proportions of copper components and polymers for the masterbatch to achieve high antimicrobial activity (≥99.99% efficiency). It is known by experts in the field and widely documented in the prior art that the performance of a copper-based formulation depends on the type of copper used and the specific combination of its components. Therefore, a higher concentration of copper or nano-copper does not necessarily yield a better antimicrobial effect.

### Antimicrobial Polymeric Material and Derived Air Filters

The polymeric material is composed of proportions of the masterbatch and low-density polyethylene. To generate a derived air filter from material samples, a matrix was used for plastic injection molding.

The filter is composed of the masterbatch in concentrations ranging from 0 to 20%, and LLDPE in concentrations of 80 to 90% (see Table 5). In one preferred embodiment of the invention, the antimicrobial polymeric material comprises 15% masterbatch and 85% linear low-density polyethylene (LLDPE).

In another embodiment, the antimicrobial polymeric material comprises 20% masterbatch and 80% linear low-density polyethylene (LLDPE). In another embodiment of the invention, the antimicrobial polymeric material comprises 10% masterbatch and 90% linear low-density polyethylene (LLDPE).

This polymeric material can be included in an injection matrix to shape a derived product for mass production. In the context of the invention, the polymeric material can take the form of fiber, thread, sheet, or other matrix pieces, or be produced via mold tooling.

Using the antimicrobial polymeric material of the invention, it is possible to generate derived products with antimicrobial properties.

The scope of the invention also includes an antibacterial air filter composed of or formulated with the antimicrobial polymeric material.

The antibacterial air filter of the present invention can be installed or mounted in air conditioning units of various uses, applications, or circumstances. This includes, without limitation, installation in domestic, industrial, refrigeration, hospital, automotive, or any type of air conditioning or climate control and refrigeration system.

The air filter may have different sizes, adapting its dimensions according to the target air inlet size. Examples of filter dimensions include 10×14 cm, 16×16 cm, 24×24 cm.

The air filter, within the scope of this invention, has been evaluated and certified under Chilean Standard NCh3241: 2017, which corresponds to refrigeration and climate control systems that include best practices in design, assembly, installation, and maintenance. It was demonstrated that filters manufactured from the antimicrobial polymeric material comply with the best practices for such systems.

In Application Example 4 of this document, an evaluation of the antimicrobial activity of prototype filters made with the invention's antimicrobial polymeric material is presented. The results showed that filters made or manufactured with the invention's material exhibited antibacterial activity against S. aureus and E. coli.

It is evident that the inventors conducted multiple tests to determine the best masterbatches, combinations, and proportions of the masterbatch and polymer components, in order to improve their effectiveness as antimicrobial/antibacterial agents. In this case, activity is determined by efficiency percentage.

Results are presented from filters within the scope of the invention that show effectiveness in eliminating the bacteria at 99.99% efficiency. In practical terms, this means that the filters reduced bacterial counts by four orders of magnitude, confirming their antimicrobial, specifically antibacterial effect. For instance, filter F3-15 reduces the initial bacterial count by four orders of magnitude: E. coli from 2.42×10⁶ CFU/mL to 3.33×10² CFU/mL and S. aureus from 1.33×10⁶ CFU/mL to 8.33×10² CFU/mL. The same effect was observed in filters F3-15, F4-20, F5-10, F5-15, and F5-20.

In practice, a reduction of four orders of magnitude in bacterial count means the difference between air that is clean and uncontaminated compared to an air that is not an air conditioner with basal bacterial contamination.

In addition, the filters are capable of reducing the growth of the bacteria S. choleraesuis ATCC 10708, L. monocytogenes ATCC 7644, and E. faecalis ATCC 29212. Specifically, filter F3-15 reduces by 3 orders of magnitude the concentration of S. choleraesuis, L. monocytogenes, and E. faecalis when compared to a control filter without the invention's masterbatch.

The filters also exhibit antifungal activity against fungi such as Botrytis cinerea and Aspergillus niger, reducing their growth by 2 to 3 orders of magnitude.

The filters of the present invention were also evaluated in an environmental pilot test. Thus, filters were installed in three household air conditioning units, and a bacterial count was conducted based on the bacteria recovered by the filters during the 25 days they remained in the domestic air conditioning units. All bacterial counts were lower compared to the control. This demonstrates that filters made from antimicrobial polymeric material are effective when installed in various types of air conditioners to eliminate or reduce bacterial contaminants.

### Definitions

In this document, the term “optical density” refers to a physical magnitude that measures the absorption of an optical element per unit of distance.

When the document refers to “optical density,” it refers to determining the growth of a bacterial culture. In this case, “optical density” is determined by the change in light intensity incident on the culture and the transmitted light, using a spectrophotometer.

The terms “efficiency percentage” or “efficiency (%)” refer to the calculation used to determine the inhibition efficiency of bacterial growth. The “% efficiency” was calculated as follows:

$$\% E = ( ( Nc - Nm ) / Nc ) \times 100$$

Where Nc is the average number of bacteria recovered from the initial culture incubation, and Nm is the average number of bacteria recovered from the 24-hour incubation sample.

The term “LLDPE” stands for the abbreviation “linear low-density polyethylene”, which refers to a linear polymer (polyethylene) with multiple short branches. This polymer is produced at low temperature and pressure through the copolymerization of ethylene, butene, hexene, or octene or longer-chain olefins, resulting in a polymer with a narrower molecular weight distribution. This polymer is used in the production of bags, plastic wraps, lids, pipes, and others.

The term “masterbatch” refers to a blend of additives or colorants or compounds dispersed within a resin. Typically, masterbatches include base polymers such as polypropylene (PP), polyamide (PA), fiber-reinforced resins, recycled plastics, etc., where the additive blend can be uniformly distributed in the polymer (depending on the characteristics of the final product). In this case, the masterbatch consists of a base formulation and may also include antioxidants like phenols, amines, thiocompounds, calcium stearate; pigments and fillers such as carbon black, titanium oxide-anatase, hydrated chromium oxide, fiberglass; and antistatic additives selected from ammonium salts and glycol esters.

When the document mentions the term “functionalized” or “functionalization,” it refers to a chemical process performed on various materials to insert functional groups that facilitate the incorporation of other molecules with different functions. This type of chemical processing can be used for diverse applications.

The term “order of magnitude” is used to compare numbers and approximate decimals. Specifically, when “order of magnitude” of a number is indicated the value to which base 10 (log) is raised when a number is expressed in scientific notation. For example, two numbers differing by 2 orders of magnitude means one is 100 times greater than the other.

The term “pellet” refers to a general designation of any material or blend of materials that has been agglomerated or compressed into small fractions. “Pelletization” means the act of compressing and molding any material or blend thereof into pellets.

The term “matrix” used in this document refers to any type of mold used to shape a desired object. “Molded piece” refers to the manufacture of components suitable for serial production.

The term “filter,” particularly “air filter”, refers to a porous or non-porous material that enables air clarification or purification. Within the scope of the present invention, air filters with antimicrobial activity can be installed in any type of air conditioning system-residential, industrial, hospital, automotive, refrigeration system, or any other device or setting that uses air conditioning.

The term “antimicrobial activity” refers to the ability of a masterbatch, material, product, compound, or element to inhibit the growth or eliminate a population of bacteria, fungi, viruses, etc. “Antibacterial activity” refers to the ability of a masterbatch, material, product, compound or element to inhibit or eliminate bacterial populations (count). This includes reducing or eliminating bacterial proliferation or growth.

The term “colony-forming units” or “CFU” refers to a microbiological concept used to indicate the number of organisms found alive in a liquid sample. The “colony-forming units” (CFU) value or count is determined by taking an aliquot of the liquid and plating it (using a streaking method) and evaluating the number of colonies that grow in it and making a relationship between the number of colonies and the volume of the aliquot. The measure CFU/mL corresponds to the number of colony-forming units per 1 mL of culture or medium.

The term “copper compounds” refers to all compounds that contain copper in their composition.

The term “nano-copper” refers to a copper material that has been manipulated at the nanometric scale. These particles have the ability capture and release electrons and can interact with light, molecules, viruses, and bacteria. In this present invention, the nano-copper is a blend whose final presentation has particle size smaller than 100 nm, preferably under 40 nm.

### FIGURE DESCRIPTIONS

FIG. 1. Determination of antibacterial activity of copper sulfate.

This graph presents the antibacterial activity of copper sulfate at different concentrations against E. coli. Positive control is an untreated E. coli culture; Antibiotic control is tetracycline at 25 μg/mL.

FIG. 2. Determination of antibacterial activity of nano-copper.

These figures show the antibacterial activity of solid nano-copper on pathogenic strains. A) E. coli ATCC 25922 culture; B) S. aureus ATCC 6538 culture. Black arrows indicate where the nano-copper was applied; (+) indicates the positive control, tetracycline at 25 μg/mL.

FIG. 3. Determination of antimicrobial activity of copper oxychloride.

Images show antimicrobial activity of copper oxychloride at different concentrations on pathogenic strains. A) E. coli ATCC 25922 culture; B) S. aureus ATCC 6538 culture. Black arrows indicate initial concentration where growth inhibition zones can be observed; (+) is the positive control tetracycline at 25 μg/mL.

FIG. 4. Airflow pressure drop analysis.

The graph shows the airflow pressure drop curve over time for 10×14 cm filter prototypes made with different formulations.

FIG. 5. Antifungal effect analysis of filters on Botrytis cinerea and Aspergillus niger.

Photographs of the antifungal effect are presented on mycelial growth when these fungi are exposed to filter F3-15.

FIG. 6. Bacterial counts recovered by filter prototypes.

Figures show bacterial counts recovered by filters prototypes. A) bacterial count from a first domestic air conditioner; B) bacterial count from a second domestic air conditioner; C) bacterial count from an office air conditioner. F0-00 corresponds to the control where a prototype filter was used, but without functionalized.

FIG. 7. Air filter from the present invention.

Photographs of the final product made from the proposed masterbatch are presented.

### APPLICATION EXAMPLES

### Example 1. Determination of Antibacterial Activity of Raw Materials for the Masterbatch

In this application example, the various raw materials used for this invention were evaluated in order to determine their antibacterial activity of these.

### —Determination of the Antimicrobial Activity of Copper Sulfate.

For this analysis, S. aureus ATCC 6538 was cultured on Müller-Hinton agar (MH) and incubated at 37° C. for 24 hours. At the same time, MH agar plates were also prepared with different concentrations of copper sulfate (3 ppm, 5 ppm, 10 ppm, 15 ppm, 20 ppm, 25 ppm, 50 ppm, 100 ppm).

Fresh S. aureus ATCC 6538 colonies were inoculated into 3 mL of MH broth until reaching an optical density equivalent to 10⁵ bacteria/mL. This culture was then diluted 10 times in saline solution.

In triplicate, 5 μL of the diluted broth were seeded onto MH agar plates containing the various concentrations of copper sulfate. The plates were incubated at 37° C. for 24 hours.

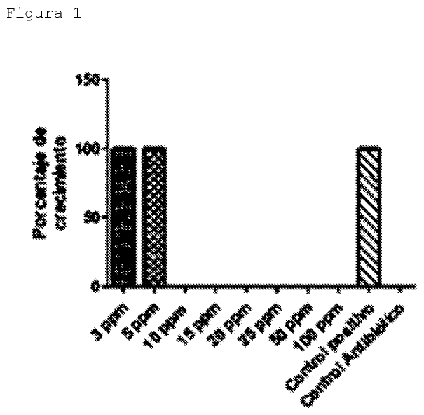

The results of this test indicate that antibacterial activity occurs in the range of 10 ppm to 100 ppm of copper sulfate (FIG. 1).

### —Determination of Antibacterial Activity of Nano-Copper.

For this test, nano-copper was used in both solid and liquid form.

In the first test, nano-copper powder was directly applied onto bacterial lawns (E. coli ATCC 25922 and S. aureus ATCC 6538 respectively). The plates were then incubated at 37° C. for 24 hours.

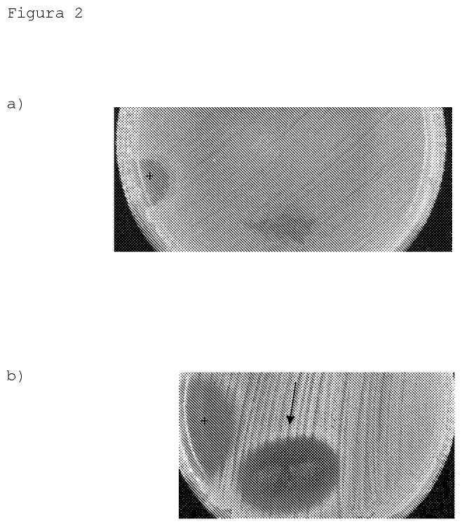

After the incubation period, a zone of growth inhibition could be observed on the bacterial lawn where the nano-copper was applied (FIG. 2).

The next test involved nano-copper in solution. A viable cell count method was used, with E. coli ATCC 25922 at 3.2×10⁶ CFU/mL and S. aureus ATCC 6538 at 2.8×10⁶ CFU/mL.

Additionally, a 100 ppm stock solution of nano-copper was prepared and a concentration gradient from 1 ppm to 100 ppm was tested. Each concentration was individually added to bacterial cultures.

The results show a decrease of one order of magnitude in bacterial counts in tests with 5 ppm to 10 ppm of nano-copper, with efficiency percentages around 70% at 10 ppm for both E. coli ATCC 25922 and S. aureus ATCC 6538 (Table 1).

TABLE 1
Determination of antibacterial activity of
nano-copper on E. coli and S. aureus.

| | Initial Count | Final Count | % Efficiency |
|---|---|---|---|
| Bacteria | 10 ppm | 10 ppm | 10 ppm |
| E. coli | 3.2 × 10⁶ | 6.6 × 10⁵ | 79.3% |
| | CFU/mL | CFU/mL | |
| S. aureus | 2.8 × 10⁶ | 8.0 × 10⁵ | 71.4% |
| | CFU/mL | CFU/mL | |

Solid and liquid nano-copper samples show antibacterial activity against E. coli ATCC 25922 and S. aureus ATCC 6538. Since growth inhibition was observed starting at 5 ppm, subsequent tests used 6 ppm as the initial concentration.

### —Determination of Antibacterial Activity of Copper Oxychloride.

An agar diffusion test was conducted for E. coli ATCC 25922 and S. aureus ATCC 6538 cultures. Copper oxychloride was added at different concentrations (4,250 ppm, 8,500 ppm, 17,000 ppm, 32,000 ppm, 60,000 ppm, 125,000 ppm). The plates were incubated at 37° C. for 24 hours.

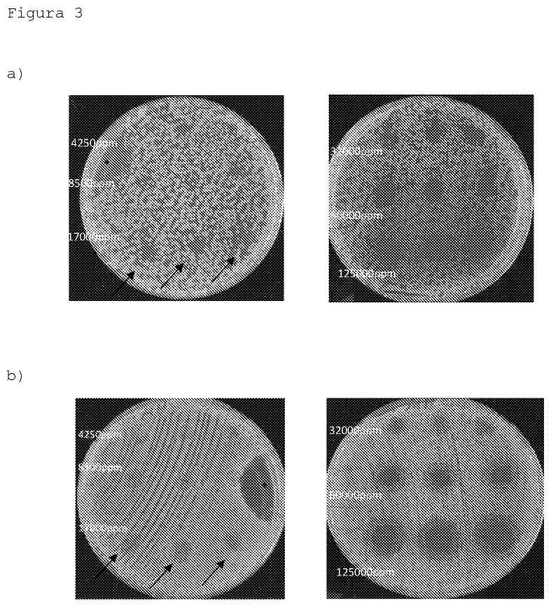

After incubation, zones of growth inhibition were observed at 17,000 ppm for both cultures (FIG. 3).

Additionally, a dilution test was performed using a 250,000 ppm (125 g/L) stock solution of copper oxychloride. A gradient was prepared using aliquots from 2,500 ppm to 100,000 ppm. A 3×10⁵ CFU/mL bacterial culture of S. aureus ATCC 6538 and a 1.25×10⁶ CFU/mL culture of E. coli ATCC 25922 were added to each solution.

The results showed no growth of S. aureus ATCC 6538 at a concentration of 5,000 ppm of copper oxychloride, while E. coli ATCC 25922 still grew at 2,500 ppm (Table 2).

TABLE 2
Determination of antibacterial activity of copper
oxychloride on E. coli and S. aureus.

| Oxychloride | | | | |
|---|---|---|---|---|
| Cu | Bacteria | Initial Count | Final Count | % Efficiency |
| 2,500 ppm | E. coli | 1.25 × 10⁶ | 5 × 10⁴ | 96.0% |
| | | CFU/mL | CFU/mL | |
| 5,000 ppm | S. aureus | 3 × 10⁵ | 2 × 10² | 99.9% |
| | | CFU/mL | CFU/mL | |

When the test was repeated using 5,000 ppm of copper oxychloride, no bacterial growth was observed, eliminating 99.9% of the bacteria.

### Example 2. Masterbatch Preparation: LLDPE Plastic Functionalization Tests with Raw Materials

In this application example, the functionalization of LLDPE plastic with the raw materials analyzed in Example 1 is described, with the purpose of imparting antibacterial properties.

—LLDPE Functionalization with Copper Sulfate

Initially, a formulation comprising 2000 ppm of copper sulfate and 3 ppm of nano-copper was prepared. This formulation was produced by mixing 100 kg of LLDPE, 12 kg of copper sulfate, and 18 g of nano-copper. At the time of passing this mixture through the extruder machine to achieve the functionalization of the LLDPE, the resulting filaments were not homogeneous, and they were also soft and brittle; therefore, they could not be pelletized. This was likely caused by the water present in the copper sulfate, which, due to its hygroscopic properties, altered the mixture with the LLDPE. As a result, copper sulfate was discarded as a raw material for the functionalization of LLDPE.

—LLDPE Functionalization with Copper Oxychloride

A second LLDPE plastic functionalization with the raw material was performed, a formulation comprising 25 kg of LLDPE, 1.5 kg of copper oxychloride and 1.5 g of nano-copper. This formularion was fed into an extruder machine to obtain a masterbatch, which exhibits resistance and malleability features that are similar to an unfunctionalized masterbatch (Table 3).

TABLE 3
Characteristics of non-functionalized
LLDPE vs. functionalized LLDPE

| | |
|---|---|
| Non-functionalized | Functionalized |
| LLDPE | LLDPE |

Physical Properties

| | | | | |
|---|---|---|---|---|
| Density | 0.926 | g/cm³ | 0.937 | g/cm³ |
| Melting Index (190° C./ | 50 | g/10 min | 50 | g/10 min |
| 2.16 kg) (122° F. | 5.00 | h | 5.00 | h |
| (50° C.), 100% Igepal, | | | | |
| F50) | | | | |

Mechanical Properties

| Stress | | | | |
|---|---|---|---|---|
| Yield Point | 9.65 | MPa | 9.45 | MPa |
| Break | 7.58 | MPa | 7.54 | MPa |
| Stress | | | | |
| Yield Point | 3.0% | | 1.2% | |
| Break | 120% | | 121% | |
| Impact Resistance | 189 | kJ/m² | 185 | kJ/m² |

| | | |
|---|---|---|
| Hardness | 52 | 51 |

Thermal Properties

| | | | | |
|---|---|---|---|---|
| Deflection Temperature | 45° | C. | 44° | C. |
| under 66 psi (0.45 MPa) | | | | |
| load, non-annealed | | | | |
| Brittleness Temperature | −76.1° | C. | −74.3° | C. |
| Softening Temperature | 90° | C. | 89° | C. |
| Melting Temperature | 124° | C. | 126° | C. |
| (Dynamic Scanning | | | | |
| Calorimetry, DSC) | | | | |
| Maximum Crystallyzation | 109° | C. | 110° | C. |
| Temperature (Dynamic | | | | |
| Scanning Calorimetry, DSC) | | | | |

### · Evaluation of the Functionalized Masterbatch Samples

Five different formulations of LLDPE with copper oxychloride and nano-copper were prepared for masterbatch, with the aim of evaluating which had the best antimicrobial activity. The formulations are as follows:

| | | Amount of | Amount of | Oxychloride |
|---|---|---|---|---|
| Formu- | Amount of | Copper | Nano-copper | (ppm)/ |
| lations | LLDPE | Oxychloride | (NanoCu) | NanoCu (ppm) |
| 1 | 25 kg | 1.5 kg | 1.5 g | 60,000/60 |
| 2 | 25 kg | 2.5 kg | 2.5 g | 100,000/100 |
| 3 | 25 kg | 3.0 kg | 3.0 g | 120,000/120 |
| 4 | 25 kg | 3.5 kg | 3.0 g | 140,000/120 |
| 5 | 25 kg | 4.0 kg | 3.0 g | 160,000/120 |

To determine the antibacterial activity of the masterbatches with the different formulations, a triplicate test was performed, in which 1 g of masterbatch was incubated in 2 mL of saline solution with a bacterial concentration of 1.3×10⁶ CFU/mL for S. aureus ATCC 6538 and 1.25×10⁶ CFU/mL for E. coli ATCC 25922, under agitation for 24 hours at 37° C. To evaluate the antibacterial effect of each formulation, the percentage of growth inhibition efficiency (% E) was determined (Table 4).

TABLE 4
Efficiency in inhibiting the growth of bacteria from masterbatch.

| Formu- | | | | |
|---|---|---|---|---|
| lations | Bacteria | Initial Count | Final Count | % Efficiency |
| 1 | E. coli | 3.0 × 10⁶ | 7.0 × 10³ | 99.8% |
| | | (CFU/mL) | (CFU/mL) | |
| | S. aureus | 1.0 × 10⁶ | 3.0 × 10³ | 99.7% |
| | | (CFU/mL) | (CFU/mL) | |
| 2 | E. coli | 1.25 × 10⁶ | 5.0 × 10³ | 99.9% |
| | | (CFU/mL) | (CFU/mL) | |
| | S. aureus | 1.3 × 10⁶ | 3.0 × 10² | 99.9% |
| | | (CFU/mL) | (CFU/mL) | |
| 3 | E. coli | 2.6 × 10⁷ | 6.0 × 10³ | 99.99% |
| | | (CFU/mL) | (CFU/mL) | |
| | S. aureus | 3.0 × 10⁷ | 6.0 × 10² | 99.99% |
| | | (CFU/mL) | (CFU/mL) | |
| 4 | E. coli | 2.6 × 10⁷ | 4.0 × 10³ | 99.99% |
| | | (CFU/mL) | (CFU/mL) | |
| | S. aureus | 3.0 × 10⁷ | 2.0 × 10² | 99.99% |
| | | (CFU/mL) | (CFU/mL) | |
| 5 | E. coli | 2.6 × 10⁷ | 1.5 × 10³ | 99.99% |
| | | (CFU/mL) | (CFU/mL) | |
| | S. aureus | 3.0 × 10⁷ | 2.0 × 10² | 99.99% |
| | | (CFU/mL) | (CFU/mL) | |
| Control | E. coli | 3.0 × 10⁶ | 3.0 × 10⁵ | 90.0% |
| Copper-free | | (CFU/mL) | (CFU/mL) | |
| masterbatch | S. aureus | 1.3 × 10⁶ | 2.0 × 10⁵ | 84.6% |
| | | (CFU/mL) | (CFU/mL) | |

The results shown in Table 4 indicate that from formulation 3 an efficiency of 99.99% is obtained, meaning it eliminates 4 orders of magnitude of the tested bacteria. In contrast, non-functionalized LLDPE is only capable of reducing the tested bacterial count by 1 order of magnitude.

### Example 3. Design and Fabrication of Prototypes

The prototype fabrication was carried out using a matrix for the manufacturing of a product through plastic injection. The prototype consists of a plastic matrix of 10×14 cm, and the masterbatch in concentrations ranging from 0 to 20%. These formulations are shown in Table 5.

TABLE 5
Formulations for the evaluation of the antimicrobial prototype.

| Formu- | Sample | | Low-Density |
|---|---|---|---|
| lation | Name | MasterBatch | Polyethylene |
| 1 | F1-00 | 0% | 100% |
| | F1-05 | 5% | 95% |
| | F1-10 | 10% | 90% |
| | F1-15 | 15% | 85% |
| | F1-20 | 20% | 80% |
| 2 | F2-00 | 0% | 100% |
| | F2-05 | 5% | 95% |
| | F2-10 | 10% | 90% |
| | F2-15 | 15% | 85% |
| | F2-20 | 20% | 80% |
| 3 | F3-00 | 0% | 100% |
| | F3-05 | 5% | 95% |
| | F3-10 | 10% | 90% |
| | F3-15 | 15% | 85% |
| | F3-20 | 20% | 80% |
| 4 | F4-00 | 0% | 100% |
| | F4-05 | 5% | 95% |
| | F4-10 | 10% | 90% |
| | F4-15 | 15% | 85% |
| | F4-20 | 20% | 80% |
| 5 | F5-00 | 0% | 100% |
| | F5-05 | 5% | 95% |
| | F5-10 | 10% | 90% |
| | F5-15 | 15% | 85% |
| | F5-20 | 20% | 80% |

The prototype consists of an antibacterial filter that can be used in different ventilation systems. With the prototype manufactured using the different formulations described in Table 5, the airflow through it was analyzed using a pressure drop analysis according to the Chilean standard NCh3241: 2017, which corresponds to refrigeration and air conditioning systems which includes best practices in design, assembly, installation, and maintenance.

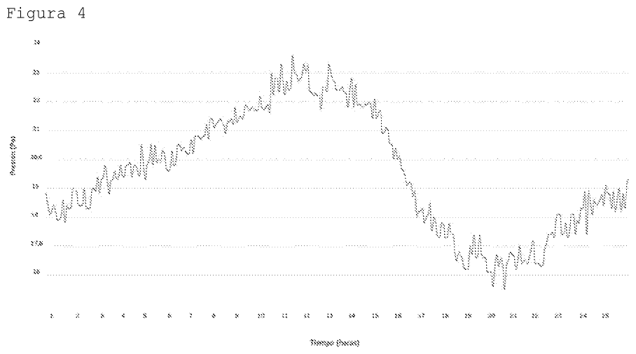

The result of the airflow pressure evaluation can be observed in FIG. 4, which shows a pressure performance curve of the filter prototype in conjunction with a dust filter (which are part of air conditioning devices). It can be observed that the peak of the sinusoidal wave is the highest pressure drop that the equipment had with the prototype filter, not reaching a value of 24 Pa. The typical pressure drop for a clean filter is 25 mm of water column (2.54 cm) or 250 Pa. The prototype filter reached a value below 10% of that limit, measured over 24 hours.

### Example 4. Evaluation of the Antimicrobial Activity of the Filter Prototypes

• Evaluation of the Antimicrobial Effect of Filter Prototypes In Vitro on E. coli and S. aureus

To evaluate the antimicrobial activity of the prototypes, a test was performed in which portions of the different prototypes (with the different formulations) measuring 3.0×1.2 cm were cut. These pieces were placed into 50 mL centrifuge tubes, and saline solution with S. aureus and E. coli bacteria was added, at a concentration of 1.5×10⁶ CFU/mL and 3×10⁶ CFU/mL respectively. The tubes were incubated at 37° C. for 24 hours. Bacteria recovery was then performed by counting colony-forming unit per milliliter (CFU/mL) by serial dilution. These results can be observed in Table 6.

TABLE 6
In vitro antimicrobial activity of filter
prototypes with different masterbatches

| | E. coli | | | S. aureus | | |
|---|---|---|---|---|---|---|
| | Initial | Final | % | Initial | Final | % |
| | Count | Count | Effi- | Count | Count | Effi- |
| Blend | (CFU/mL) | (CFU/mL) | ciency | (CFU/mL) | (CFU/mL) | ciency |
| F1-00 | 2.42 × 10⁶ | 1.52 × 10⁵ | 93.72% | 1.33 × 10⁶ | 2.23 × 10⁴ | 98.33% |
| F1-05 | | 2.10 × 10⁴ | 99.13% | | 5.83 × 10³ | 99.56% |
| F1-10 | | 1.05 × 10⁴ | 99.57% | | 6.67 × 10³ | 99.50% |
| F1-15 | | 3.83 × 10³ | 99.84% | | 1.33 × 10³ | 99.90% |
| F1-20 | | 7.50 × 10³ | 99.69% | | 4.00 × 10³ | 99.70% |
| F2-00 | 2.42 × 10⁶ | 2.10 × 10⁵ | 91.31% | 1.33 × 10⁶ | 2.30 × 10⁴ | 98.28% |
| F2-05 | | 7.70 × 10³ | 99.68% | | 2.50 × 10³ | 99.81% |
| F2-10 | | 5.00 × 10³ | 99.79% | | 2.83 × 10³ | 99.79% |
| F2-15 | | 3.34 × 10⁵ | 86.19% | | 1.67 × 10² | 100% |
| F2-20 | | 3.40 × 10⁵ | 85.93% | | 1.87 × 10³ | 99.86% |
| F3-00 | 2.42 × 10⁶ | 1.22 × 10⁶ | 49.63% | 1.33 × 10⁶ | 2.23 × 10⁴ | 98.33% |
| F3-05 | | 4.00 × 10³ | 99.83% | | 2.00 × 10³ | 99.85% |
| F3-10 | | 3.17 × 10³ | 99.87% | | 2.17 × 10³ | 99.84% |
| F3-15 | | 3.33 × 10² | 99.99% | | 8.33 × 10² | 99.94% |
| F3-20 | | 8.00 × 10³ | 99.67% | | 2.17 × 10³ | 99.84% |
| F4-00 | 2.42 × 10⁶ | 1.13 × 10⁵ | 95.34% | 1.33 × 10⁶ | 2.30 × 10⁴ | 98.28% |
| F4-05 | | 7.50 × 10³ | 0.00% | | 2.17 × 10³ | 99.84% |
| F4-10 | | 5.48 × 10⁴ | 97.73% | | 5.12 × 10⁴ | 96.16% |
| F4-15 | | 3.33 × 10³ | 99.86% | | 1.00 × 10³ | 99.93% |
| F4-20 | | 3.33 × 10² | 99.99% | | 3.40 × 10⁴ | 97.45% |
| F5-00 | 2.42 × 10⁶ | 1.13 × 10⁴ | 99.53% | 1.33 × 10⁶ | 2.23 × 10⁴ | 98.33% |
| F5-05 | | 4.20 × 10³ | 99.83% | | 8.33 × 10² | 99.94% |
| F5-10 | | 5.00 × 10² | 99.98% | | 1.00 × 10³ | 99.93% |
| F5-15 | | 3.33 × 10² | 99.99% | | 3.33 × 10² | 99.98% |
| F5-20 | | 1.50 × 10³ | 99.94% | | 7.50 × 10² | 99.94% |

According to the data shown in Table 6, the filter prototypes manufactured with mixtures F3-15, F4-20, F5-10, F5-15, and F5-20 demonstrate effectiveness in eliminating the tested bacteria at a rate of 99.99%. This means that all these filters reduced the initial bacterial count by 4 orders of magnitude, proving their antibacterial effect. For example, F3-15 reduced the initial bacterial count by 4 orders of magnitude from 2.42×10⁶ CFU/mL to 3.33×10² CFU/mL for E. coli and from 1.33×10⁶ CFU/mL to 8.33×10² CFU/mL for S. aureus. This same effect was observed for all filters F3-15, F4-20, F5-10, F5-15, and F5-20.

For the case of control filters, composed only of polyethylene (F1-00, F2-00, F3-00, F4-00, and F5-00), the initial bacterial count was also reduced, but only by 1 or 2 orders of magnitude.

—Evaluation of the Antimicrobial Effect of Filter Prototype F3-15 In Vitro on Salmonella choleraesuis ATCC 10708, Listeria monocytogenes ATCC 7644, and Enterococcus faecalis ATCC 29212

The antimicrobial effect of one of the filter prototypes with the best results was determined on Salmonella choleraesuis ATCC 10708, Listeria monocytogenes ATCC 7644, and Enterococcus faecalis ATCC 29212.

Once the microorganisms were grown for 24 hours, an inoculum was prepared in 0.9% saline solution, and the concentration was adjusted through serial dilution on MH agar plates.

Subsequently, for the test, an initial concentration was used as defined in Table 7 for each microorganism. These were inoculated in duplicate in 5 mL of 0.9% saline solution along with 0.5 g of each filter F0-00 (control) and F3-15 (test), those incubated for 72 hours at 37° C. with agitation. To estimate the viable microorganisms in the sample, plate counts were performed using serial dilution.

According to the results in Table 7, the filters show antimicrobial activity against the bacteria S. choleraesuis ATCC 10708, L. monocytogenes ATCC 7644, and E. faecalis ATCC 29212. Specifically, the F3-15 filter reduces the bacterial concentration by 3 orders of magnitude for S. choleraesuis ATCC 10708, L. monocytogenes ATCC 7644, and E. faecalis ATCC 29212, when compared to a control filter without the masterbatch of the invention.

TABLE 7
In vitro antimicrobial activity of F3-15 filter prototype
on S. choleraesuis ATCC 10708, L. monocytogenes ATCC
7644, and E. faecalis ATCC 29212.

| | S. choleraesuis ATCC 10708 | | | L. monocytogenes ATCC 7644 | | |
|---|---|---|---|---|---|---|
| | Initial | Final | % | Initial | Final | % |
| | Count | Count | Effi- | Count | Count | Effi- |
| Blend | (CFU/mL) | (CFU/mL) | ciency | (CFU/mL) | (CFU/mL) | ciency |
| F1-00 | 4.0 × 10⁷ | 1.2 × 10⁶ | 97.0% | 6.0 × 10⁷ | 8.0 × 10⁵ | 98.6% |
| F3-15 | | 2.5 × 10⁴ | 99.4% | | 5.0 × 10³ | 99.9% |

| | E. faecalis ATCC 29212 | | |
|---|---|---|---|
| | Initial | Final | % |
| | Count | Count | Effi- |
| Blend | (CFU/mL) | (CFU/mL) | ciency |
| F1-00 | 1.0 × 10⁷ | 1.0 × 10⁶ | 90.0% |
| F3-15 | | 3.5 × 10⁴ | 99.7% |

—Evaluation of the Antimicrobial Effect of Filter Prototype F3-15 In Vitro on Botrytis cinerea and Aspergillus niger

The antifungal effect of the F3-15 filter on the fungi Botrytis cinerea and Aspergillus niger was also determined. To this end, plate tests were carried out to determine the inhibitory effect of the filter that is part of the present invention on mycelial growth and by determining the number of fungal spores in the presence of the filter.

Once the microorganisms (Botrytis cinerea and Aspergillus niger) were grown for 72 hours, an inoculum was prepared by collecting spores from the microorganisms in 0.9% saline solution and adjusting the concentration using a Neubauer chamber to 1.8×10⁷ CFU/mL for Botrytis cinerea and 2.0×10⁷ for Aspergillus niger. The results were then confirmed by serial dilution and plate counting on YM agar (yeast-malt agar).

Subsequently, for the activity test, an initial concentration of 1.8×10⁵ CFU/mL of Botrytis cinerea and 2.0×10⁵ CFU/mL of Aspergillus niger was used. These were inoculated in duplicate: 5 mL of 0.9% saline solution along with 0.5 g of filter F0-00 (control) and F3-15 (test), which were incubated for 72 hours at 25° C. with agitation. To estimate the number of spores after 72 hours of incubation, plate counting was performed by serial dilution.

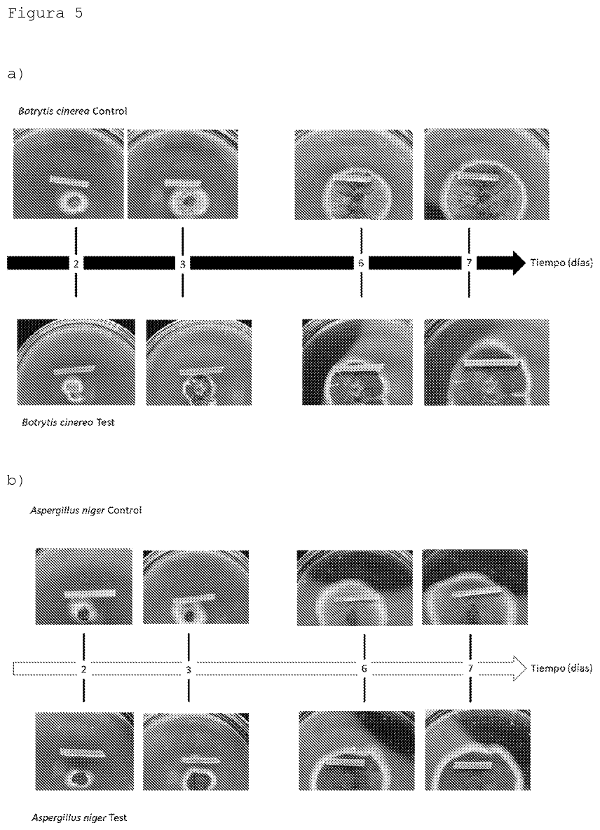

According to the results, the F3-15 filter slows or reduces mycelial growth compared to the F0-00 control filter (FIG. 5). This is confirmed by the results of the spore number determination test, which shows that the F3-15 filter decreases the initial count of Botrytis cinerea and Aspergillus niger spores by 3 and 2 orders of magnitude, respectively (Table 8).

TABLE 8
In vitro antifungal effect of F3-15 on Botrytis cinerea
and Aspergillus niger by determining the number of spores

| | | Initial Count | Final Count | |
|---|---|---|---|---|
| Microorganism | Filter | (CFU/mL) | (CFU/mL) | % Efficiency |
| Botrytis cinerea | F3-15 | 1.8 × 10⁵ | 5.0 × 10² | 99.7% |
| Botrytis cinerea | F0-00 | 1.8 × 10⁵ | 1.0 × 10⁴ | 94.4% |
| | (Control) | | | |
| Aspergillus | F3-15 | 2.0 × 10⁵ | 1.0 × 10³ | 99.5% |
| niger | | | | |
| Aspergillus | F0-00 | 2.0 × 10⁵ | 1.0 × 10⁴ | 95.0% |
| niger | (Control) | | | |

### Example 5: Evaluation of Filter Prototypes in a Pilot Environmental Test

The filters corresponding to the preparations with mixtures F3-15, F4-20, F5-10, F5-15, and F5-20 were installed in three home-type air conditioning units (all in triplicate) and left in place for 25 days. Then, the filters were removed and placed individually in sealed bags for later analysis.

For the analysis of these filters, 3.8 cm² pieces were cut from each one. These pieces were individually enriched in 20 ml of peptoned broth for 1 hour with agitation. After the hour of enrichment, the broth from each sample was taken and filtered using 0.22 μm squared membranes. The membranes were placed on MH agar plates and incubated at 37° C. for 24 hours.

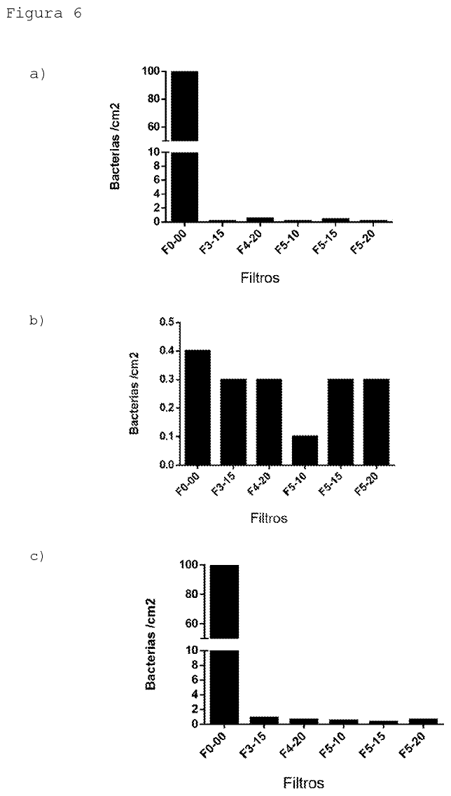

After the incubation period of the plates with membranes, a count of total bacteria was performed. These correspond to the bacteria that were recovered from the filters during the 25 days they were inside the domestic air conditioning units. All bacterial counts were lower compared to the control (FIG. 6).

From these results, it is possible to observe that the filters manufactured with the F3-15, F4-20, F5-10, F5-15, and F5-20 blends showed a lower bacterial count compared to the control (F0-00, non-functionalized). It is important to note that in the case of FIGS. 6a and 6c, the value 10 in the F0-00 control is referential, since the number of recovered bacteria is greater than 10 (>100 bacteria per cm²), and it was decided to assign a value of 10 in order to better appreciate the recovery values in the filters with functionalized LLDPE.

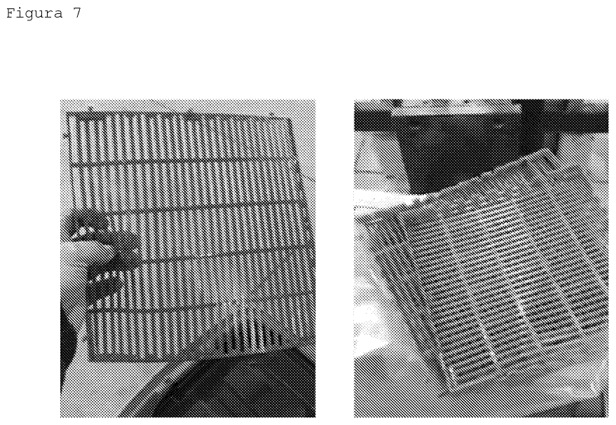

Finally, an analysis of results and raw material costs was carried out, and it was concluded that the best formulation for the filter corresponds to formulation 3 (Table 5), which includes 15% masterbatch and 85% LLDPE. From this formulation (F3-15), filters with dimensions of 24×24 cm were manufactured as one of the production options (see FIG. 7), which can be installed in any type of air conditioning system (residential, industrial, hospital, vehicles, etc.).

1. A polymeric masterbatch for preparing an antimicrobial material, comprising a formulation composed of:
25 kg of linear low-density polyethylene (LLDPE),
1.5-3.0 g of nano-copper with a particle size smaller than 100 nm, where said nano-copper is composed of a mixture of 3-50% Cu⁰ and 50-87% Cu₂O,
and 1.5-4.0 kg of copper oxychloride, where the copper oxychloride (ppm)/nanocopper (ppm) ratio is 120,000-160,000/120.

2. The polymeric masterbatch for preparing an antimicrobial material according to claim 1, comprising:
antioxidants such as phenols, amines, thiocompounds, calcium stearate and/or,
pigments and fillers such as carbon black, titanium oxide-anatase, hydrated chromium oxide, fiberglass and/or,
antistatic additives such as ammonium salts and glycol esters.

3. The polymeric masterbatch for preparing an antimicrobial material according to claim 1, wherein the nano-copper in the formulation has a particle size smaller than 40 nm.

4. The polymeric masterbatch for preparing an antimicrobial material according to claim 1, wherein the formulation the oxychloride (ppm)/nano-copper (ppm) ratio is 120,000/120.

5. A polymeric masterbatch for preparing an antimicrobial material according to claim 1, wherein the formulation the oxychloride (ppm)/nano-copper (ppm) ratio is 140,000/120.

6. The polymeric masterbatch for preparing an antimicrobial material according to claim 1, wherein the formulation the oxychloride (ppm)/nano-copper (ppm) ratio is 160,000/120.

7. The polymeric masterbatch for preparing an antimicrobial material according to claim 1, wherein the formulation comprises 25 kg of LLDPE, 1.5 kg of copper oxychloride and 1.5 g of nano-copper.

8. The polymeric masterbatch for preparing an antimicrobial material according to claim 1, wherein the formulation comprises 25 kg of LLDPE, 3.0 kg of copper oxychloride and 3.0 g of nano-copper.

9. The polymeric masterbatch for preparing an antimicrobial material according to claim 1, wherein the formulation comprises 25 kg of LLDPE, 4.0 kg of copper oxychloride and 3.0 g of nano-copper.

10. The polymeric masterbatch for preparing an antimicrobial material according to claim 1, comprising pigments and fillers such as carbon black, titanium oxide-anatase, hydrated chromium oxide and fiberglass.

11. An antimicrobial polymeric material, comprising 5% to 20% w/w of the masterbatch according to claim 1 and 80% to 95% of linear low-density polyethylene (LLDPE).

12. The antimicrobial polymeric material according to claim 11, comprising 15% of the masterbatch and 85% of linear low-density polyethylene (LLDPE).

13. The antimicrobial polymeric material according to claim 11, comprising 15% of the masterbatch and 85% of linear low-density polyethylene (LLDPE).

14. The antimicrobial polymeric material according to claim 11, comprising 20% of the masterbatch and 80% of linear low-density polyethylene (LLDPE).

15. The antimicrobial polymeric material according to claim 11, comprising 10% of the masterbatch and 90% of linear low-density polyethylene (LLDPE).

16. An antimicrobial polymeric material according to claim 11, wherein said material has the shape of a fiber, thread, sheet, or other form of matrix part.

17. An antimicrobial air filter comprising or being formulated with the antimicrobial polymeric material according to claim 11.

18. A method using the antimicrobial air filter according to claim 17 wherein it serves to filter the air and in turn eliminate and reduce the growth of bacteria and fungi.

19. A method using the antimicrobial air filter according to claim 17 wherein it serves to reduce bacterial growth of E. coli and S. aureus.

20. A method using the antimicrobial air filter according to claim 17 wherein it serves to reduce bacterial growth of Salmonella Choleraesuis, Listeria monocytogenes and Enterococcus faecalis.

21. A method using the antimicrobial air filter according to claim 17 wherein it serves to reduce the growth of fungi Botrytis cinerea and Aspergillus niger.

22. A method using the antimicrobial air filter according to claim 18, wherein it is to be installed or included in air conditioning systems for industrial, domestic, hospital, or automotive use, among others.
